(19) United States
(12) Patent Application Publication
(10) Pub. No.: US 2014/0023050 A1
(43) Pub. Date: Jan. 23, 2014

(54) METHOD AND APPARATUS FOR ALLOCATING RESOURCES IN CELLULAR COMMUNICATION SYSTEM

(71) Applicant: Electronics and Telecommunications Research Institute, Daejeon (KR)

(72) Inventors: Seok SEO, Daejeon (KR); Jae Su SONG, Daejeon (KR); Yunhee CHO, Daejeon (KR); Seung-Hwan LEE, Daejeon (KR)

(21) Appl. No.: 13/943,457

(22) Filed: Jul. 16, 2013

(30) Foreign Application Priority Data
Jul. 17, 2012 (KR) 10-2012-0077811
Jul. 16, 2013 (KR) 10-2013-0083237

(51) Int. Cl. H04W 72/04

(52) U.S. Cl. CPC H04W 72/0486
USPC 370/336

(57) ABSTRACT

An apparatus for allocating resources in a cellular communication system including a plurality of cells divides time resources of one period into a plurality of time division intervals, allocates one time division interval of the plurality of time division intervals for user terminals in a cell edge region, and controls at least one of a magnitude of one period and a magnitude of the plurality of time division intervals in accordance with distributions and load distributions of user terminals of the plurality of cells.

### CROSS-REFERENCE TO RELATED APPLICATION

This application claims priority to and the benefit of Korean Patent Application Nos. 10-2012-0077811 and 10-2013-0083237 filed in the Korean Intellectual Property Office on Jul. 17, 2012 and Jul. 16, 2013, the entire contents of which are incorporated herein by reference.

### BACKGROUND OF THE INVENTION

(a) Field of the Invention

The present invention relates to a method and an apparatus for allocating resources in a cellular communication system. More particularly, the present invention relates to a method and an apparatus for allocating resources to remove inter-cell interference in a cellular communication system.

(b) Description of the Related Art

In general, in order to maximize system capacity by efficiently using radio resources, an entire service area is divided into a plurality of cells to configure a multi-cell, and a base station for providing services to terminals positioned in a cell is installed in each of the cells. In the cellular communication system, in order to increase the system capacity, frequency use efficiency must be maximized. For this purpose, the cells are designed to commonly use an entire frequency band. When neighboring cells use the same frequency band, interference is generated among the cells. The interference generated among the cells is referred to as inter-cell interference.

In particular, the inter-cell interference does not significantly matter in terminals positioned in a center region of a cell since intensities of signals received from others cells are small and that of a signal received from a serving cell is large. However, the inter-cell interference significantly deteriorates communication performance of terminals positioned in an edge region of a cell since intensities of signals received from neighboring cells are large.

In order to solve such a problem, a fractional frequency reuse (FFR) technique is suggested in order to reduce the inter-cell interference in a multi-cell environment. In the FFR technique, a cell is divided into a center region and an edge region and a frequency reuse factor of terminals positioned in the center region is set different from that of terminals positioned in the edge region. However, in the FFR technique, since frequency bands of users for the center region and the edge region are limited, a frequency domain multi-user gain is limited. For example, when a cell edge user undergoes deep fading in an allocated frequency band, the cell edge user undergoes severe performance deterioration.

### SUMMARY OF THE INVENTION

An object of the present invention is to provide a method and an apparatus for allocating resources in a cellular communication system to remove inter-cell interference and to improve resource use efficiency.

According to an exemplary embodiment of the present invention, a method of a resource allocating apparatus of a first cell allocating resources in a cellular communication system including a plurality of cells is provided. The resource allocating method includes dividing time resources of one period into a plurality of time division intervals, allocating one time division interval of the plurality of time division intervals for user terminals in a cell edge region, allocating time division intervals other than the one time division interval of the plurality of time division intervals for user terminals in a cell center region, and controlling at least one of a magnitude of one period and a magnitude of the plurality of time division intervals in accordance with distributions and load distributions of user terminals of the plurality of cells.

The time division intervals other than the one time division interval of the plurality of time division intervals may be allocated for user terminals in cell edge regions of neighboring cells of the first cell, respectively.

Allocating one time division interval of the plurality of time division intervals for user terminals in a cell edge region may include setting up transmission power in a first level in the one time division interval. Allocating time division intervals other than the one time division interval of the plurality of time division intervals for user terminals in a cell center region may include setting up the transmission power in a second level lower than the first level.

Controlling at least one of a magnitude of the one period and a magnitude of the plurality of time division intervals in accordance with distributions and load distributions of user terminals of the plurality of cells may include analyzing distribution of user terminals of the first cell, analyzing load distribution of user terminals of the first cell, and determining a magnitude of the one time division interval so that the one time division interval does not overlap the other time division intervals in accordance with distribution and load distribution of user terminals of the first cell.

Determining a magnitude of the one time division interval so that the one time division interval does not overlap the other time division intervals in accordance with distribution and load distribution of user terminals of the first cell may include determining the one time division interval in proportion to the distribution and the load distribution of the user terminals of the first cell.

Determining a magnitude of the one time division interval so that the one time division interval does not overlap the other time division intervals in accordance with distribution and load distribution of user terminals of the first cell may further include determining a magnitude of the one time division interval through negotiation with neighboring cells when it is not possible to determine the one time division interval so as to not overlap the other time division intervals.

Determining a magnitude of the one time division interval through negotiation with the neighboring cells may include receiving a resource state update message including an amount of spare time resources from a neighboring cell in an underload state of the neighboring cells and requesting required time resources from the neighboring cell in the underload state to receive the requested time resources.

Determining a magnitude of the one time division interval through negotiation with the neighboring cells may include transmitting a resource state request message to the neighboring cells, receiving a resource state response message including an amount of spare time resources from the neighboring cells, selecting a neighboring cell in an underload state with reference to the amount of the spare time resources of the resource state response message, and requesting time resources from the selected neighboring cell to receive the requested time resources.

Analyzing distribution of the user terminals may include classifying the user terminals into user terminals positioned in a cell edge region and user terminals positioned in a cell center region based on intensities of received signals of the user terminals.

Classifying the user terminals into user terminals positioned in a cell edge region and user terminals positioned in a cell center region based on intensities of received signals of the user terminals may include receiving intensities of received signals of user terminals of the first cell from the user terminals.

Classifying the user terminals into user terminals positioned in a cell edge region and user terminals positioned in a cell center region based on intensities of received signals of the user terminals may include measuring intensities of received signals of user terminals of the first cell.

According to another exemplary embodiment of the present invention, a resource allocating apparatus of a first cell in a cellular communication system including a plurality of cells is provided. The resource allocating apparatus includes a controller and a transmitter. The controller divides time resources of one period into a plurality of time division intervals, allocates one time division interval of the plurality of time division intervals for user terminals in a cell edge region, and controls at least one of a magnitude of one period and a magnitude of the plurality of time division intervals in accordance with distributions and load distributions of user terminals of the plurality of cells. The transmitter transmits information of the first time division interval to neighboring cells.

The controller may allocate time division intervals other than the one time division interval of the plurality of time division intervals for user terminals in a cell center region, and the other time division intervals may be allocated for user terminals in cell edge regions of neighboring cells of the first cell, respectively

The controller may set up transmission power in a first level in the one time division interval and may set up the transmission power in a second level lower than the first level in the other time division intervals.

The controller may determine a magnitude of the one time division interval so that the one time division interval does not overlap the other time division intervals in accordance with distribution and load distribution of user terminals of the first cell.

The controller may determine the magnitude of the one time division interval through negotiation with the neighboring cells.

The resource allocating apparatus may further include a receiver. The receiver receives resource allocation messages from the neighboring cells. At this time, when a message including an amount of spare time resources is received from a neighboring cell in an underload state of the neighboring cells, the controller may increase the one time division interval using the spare time resources of the neighboring cell in the underload state.

The controller may analyze distribution of user terminals of the first cell and load distribution of user terminals of the first cell, and may determine the one time division interval in proportion to the distribution of the user terminals of the first cell and the load distribution of the user terminals of the first cell. The transmitter may transmit the load distribution of the user terminals of the first cell to the neighboring cells.

The resource allocating apparatus may further include a receiver. The receiver receives load distributions of user terminals of neighboring cells from the neighboring cells. At this time, the controller may determine a magnitude of the one period in accordance with load distributions of user terminals of the plurality of cells. The magnitude of the one period may be changed within limits where delay requirements required by user quality of service (QoS) are satisfied.

### BRIEF DESCRIPTION OF THE DRAWINGS

FIG. 1 is a view illustrating an example of a cellular communication system according to an exemplary embodiment of the present invention.

FIG. 2 is a view illustrating a radio resource structure according to an exemplary embodiment of the present invention.

FIG. 3 is a view schematically illustrating a method of allocating resources according to an exemplary embodiment of the present invention.

FIG. 4 is a view illustrating a method of allocating resources according to an exemplary embodiment of the present invention in accordance with time.

FIGS. 5 and 6 are views schematically illustrating a method of allocating resources according to another exemplary embodiment of the present invention.

FIG. 7 is a flowchart illustrating a method of allocating resources according to an exemplary embodiment of the present invention.

FIG. 8 is a view illustrating an example of a method of exchanging information with neighboring cells according to an exemplary embodiment of the present invention.

FIG. 9 is a view illustrating another example of a method of exchanging information with neighboring cells according to an exemplary embodiment of the present invention.

FIG. 10 is a view illustrating an apparatus for allocating resources according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Hereinafter, a method and an apparatus for allocating resources in a cellular communication system according to an embodiment of the present invention will be described in detail with reference to the drawings.

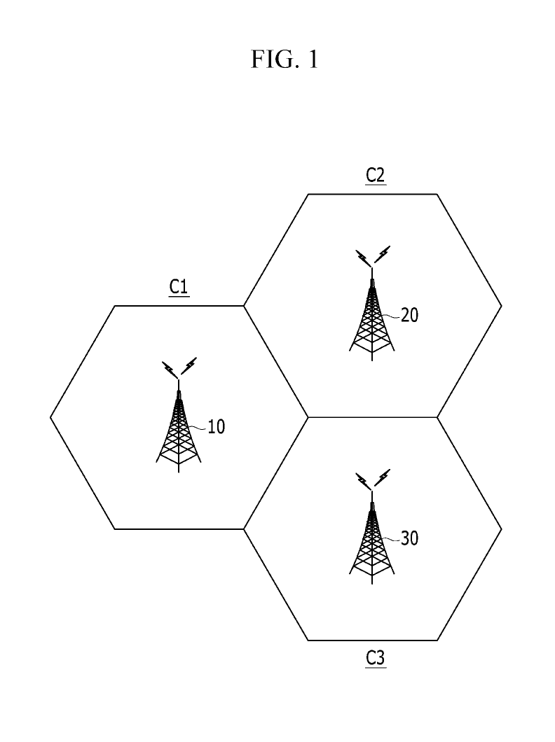

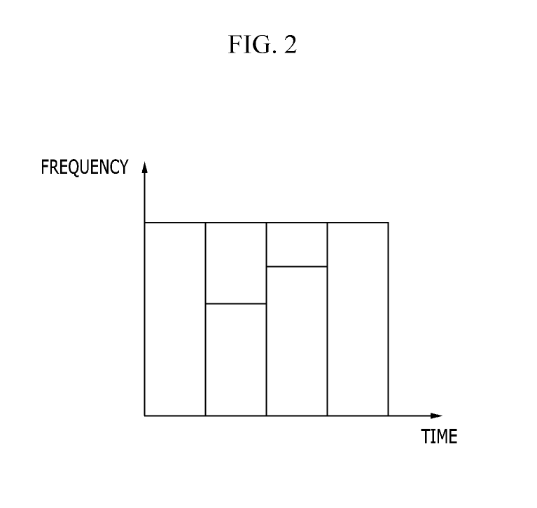

FIG. 1 is a view illustrating a cellular communication system according to an exemplary embodiment of the present invention, and FIG. 2 is a view illustrating a radio resource structure according to an exemplary embodiment of the present invention.

Referring to FIG. 1, a cellular communication system includes a plurality of cells C1, C2, and C3. The cells C1, C2, and C3 include base stations 10, 20, and 30, respectively. The base stations 10, 20, and 30 communicate with terminals in the cells C1, C2, and C3 using radio resources, respectively.

Referring to FIG. 2, radio resources may be defined by a two-dimensional domain of time and frequency.

The base stations 10, 20, and 30 divide a time domain to allocate resources to the cells C1, C2, and C3 and to remove inter-cell interference. As described above, in a fractional time reuse (FTR) technique, a time domain is divided to allocate resources and to remove inter-cell interference.

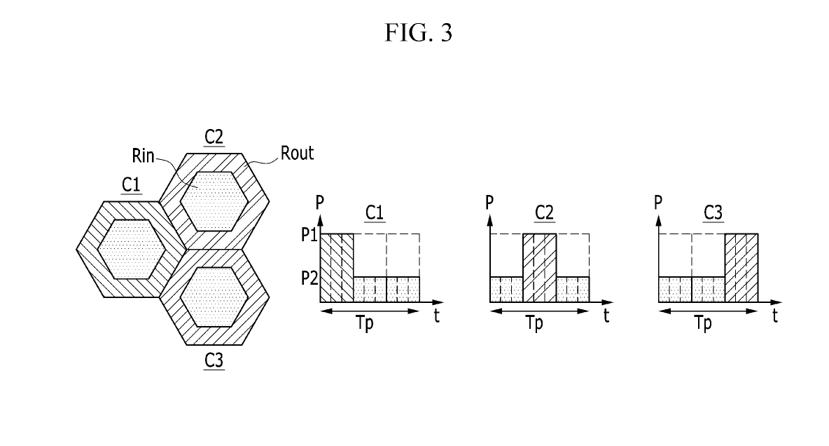

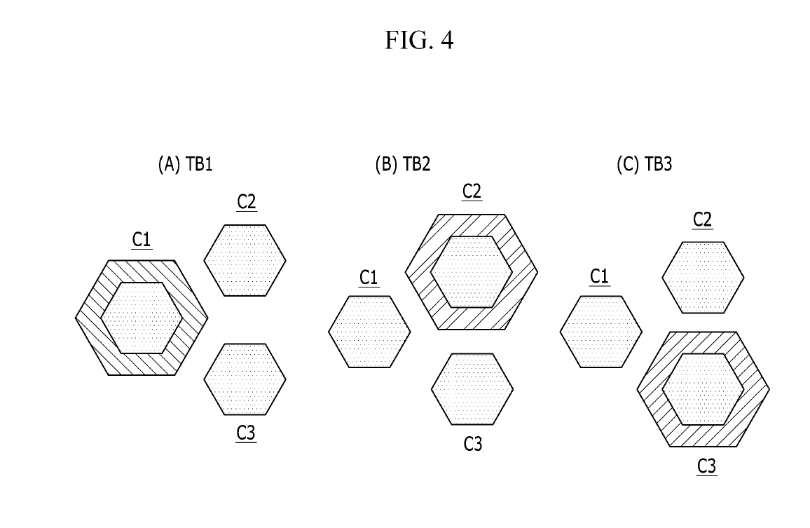

FIG. 3 is a view schematically illustrating a method of allocating resources according to an exemplary embodiment of the present invention, and FIG. 4 is a view illustrating a method of allocating resources according to an exemplary embodiment of the present invention in accordance with time.

Referring to FIG. 3, when the cells C1, C2, and C3 of the cellular communication system are divided into three cell types, time resources of one time resource division period Tp may be divided into three time division intervals TB1, TB2, and TB3. Each of the time division intervals TB1, TB2, and TB3 includes a plurality of time slots.

The time division intervals TB1, TB2, and TB3 are exclusively allocated to serve user terminals positioned in edge regions Rout of the cells C1, C2, and C3. The time division intervals that are not used in the edge regions Rout of the cells C1, C2, and C3 are commonly used in center regions Rin of the cells C1, C2, and C3.

As illustrated in FIG. 4, in the time division interval TB1, resources for user terminals positioned in the edge region Rout of the cell C1 are allocated and resources for user terminals positioned in the center regions Rin of the cells C2 and C3 are allocated. In the time division interval TB2, resources for user terminals positioned in the edge region Rout of the cell C2 are allocated and resources for user terminals positioned in the center regions Rin of the cells C1 and C3 are allocated. In the time division interval TB3, resources for user terminals positioned in the edge region Rout of the cell C3 are allocated and resources for user terminals positioned in the center regions Rin of the cells C1 and C2 are allocated.

At this time, since the time division intervals allocated to the center regions Rin of the cells C1, C2, and C3 and time division intervals allocated to edge regions Rout of neighboring cells of the cells C1, C2, and C3 overlap each other, cells that receive the time division intervals TB1, TB2, and TB3 allocated to the edge regions Rout allow transmission of high power P1 and the other cells allow transmission of low power P2 so that interference is not generated between the time division intervals. For example, in the time division interval TB1, the cell C1 performs transmission of the high power P1 and the cells C2 and C3 perform transmission of the low power P2.

When the time domain is divided in this way, in the time division intervals TB1, TB2, and TB3 to which the cells are allocated, since user terminals may be served using an entire frequency band, a frequency selective gain may be provided to the user terminals positioned in the cell center regions Rin and the cell edge regions Rout.

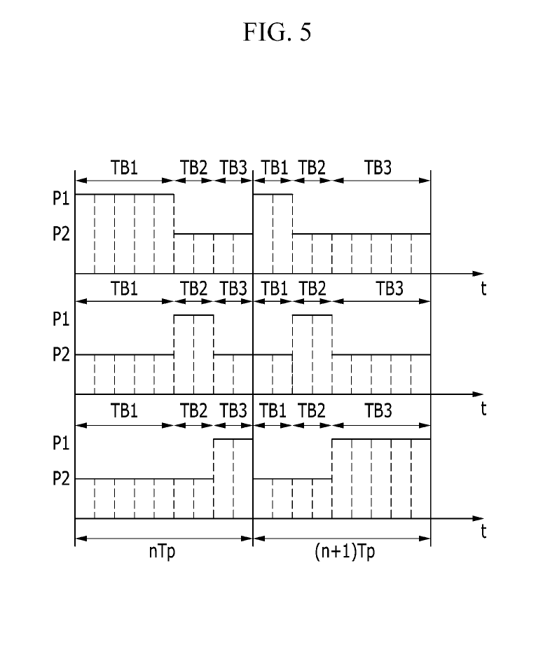

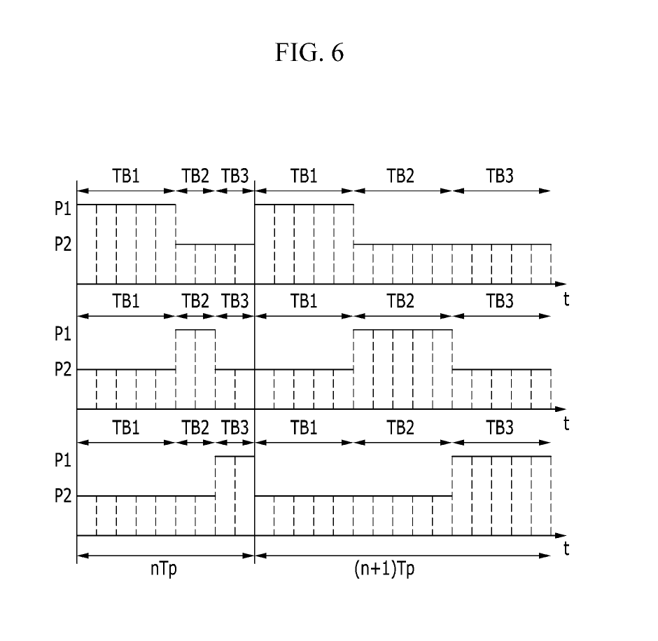

FIGS. 5 and 6 are views illustrating a method of allocating resources according to another exemplary embodiment of the present invention.

Referring to FIGS. 5 and 6, in one time division period Tp, a ratio of the time division intervals TB1, TB2, and TB3 allocated to the edge regions of the cells may be increased or reduced in accordance with a degree of imbalance of user distributions or loads of the cells. In addition, the time division period Tp may also be increased or reduced in accordance with the degree of imbalance of the user distributions or the loads of the cells.

As illustrated in FIG. 5, in an nth time division period nTp, when a large number of cell edge user terminals of the cell C1 exist, the time division interval TB1 may be increased and the time division intervals TB2 and TB3 may be reduced. In an (n+1)th time division period (n+1)Tp, when cell edge user terminals of the cell C1 are reduced and cell edge user terminals of the cell C3 are increased, the time division interval TB1 may be reduced and the time division interval TB3 may be increased.

In addition, as illustrated in FIG. 6, in the n-th time division period nTp, a small number of cell edge user terminals of the cells C2 and C3 exist, however, in the (n+1)th time division period (n+1)Tp, the cell edge user terminals of the cells C2 and C3 are increased so that distribution of the cell edge user terminals is entirely increased. Therefore, in order to accommodate the cell edge user terminals, the time division period Tp may be increased. The time division period Tp may not be limitlessly increased but may be increased within limits where delay requirements required by user quality of service (QoS) may be satisfied.

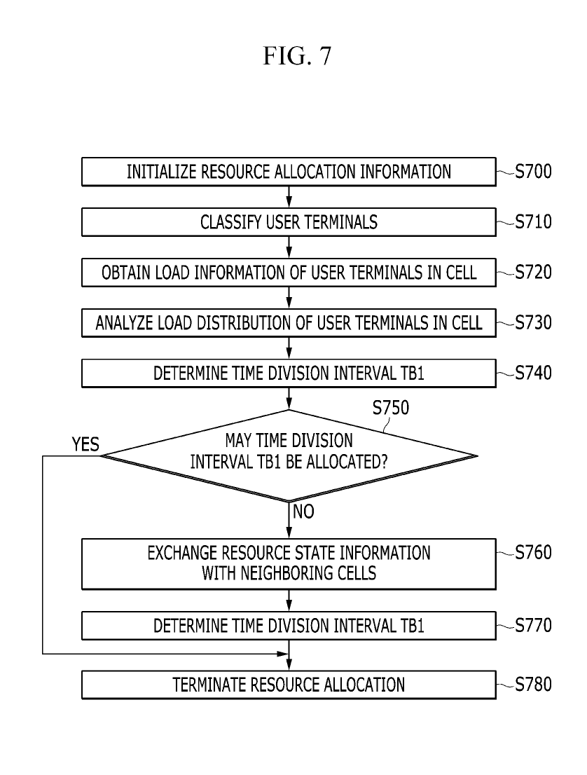

FIG. 7 is a flowchart illustrating a method of allocating resources according to an exemplary embodiment of the present invention. In FIG. 7, for convenience sake, description will be made based on the base station 10 of the cell C1 and the base stations 20 and 30 of the cells C2 and C3 may operate in the same way as or in a similar way to that of the base station 10.

Referring to FIG. 7, the base station 10 initializes resource allocation information of the cell C1 (S700). The resource allocation information may include the time division period Tp and the time division intervals TB1, TB2, and TB3. At this time, since there is no information on measured distribution or load distribution of user terminals, the base station 10 previously allocates a predetermined time division period Tp and the time division intervals TB1, TB2, and B3 to the cell C1. For example, the base station 10 allocates the time division interval TB1 for user terminals in a cell edge region and allocates the time division intervals TB2 and TB3 for user terminals in a cell center region.

When a cellular communication system supports an operations, administration, and maintenance (OAM) function so that information on load distribution of user terminals of each cell is provided at a current point in time, the base station 10 may set up the time division period Tp and the time division intervals TB1, TB2, and TB3 based on load distribution of user terminals of the cell C1.

The base station 10 classifies user terminals in the cell C1 into terminals (hereinafter referred to as “cell center users”) positioned in a cell center region and terminals (hereinafter referred to as “cell edge users”) positioned in a cell edge region (S710) to analyze distribution of the user terminals.

The base station 10 measures intensities of received signals of the user terminals to classify the user terminals into the cell center users and the cell edge users. The base station 10 may determine user terminals as the cell center users when the intensities of the received signals of the user terminals are no less than a threshold value, and may determine user terminals as the cell edge users when the intensities of the received signals of the user terminals are no more than a threshold value. In addition, the base station 10 may be notified about the intensities of the received signals by the user terminals. The user terminals measure the intensities of the received signals to report the measured intensities of the received signals to the base station 10. In order to let the base station 10 classify the user terminals, the user terminals may measure intensities of received signals of neighboring cells through a cell search process and may report the measured intensities of the received signals to the base station. In addition, the user terminals may directly compare the intensities of the received signals with the threshold value to determine user terminals as the cell center users or the cell edge users. In this case, the user terminals may report change information to the base station 10 only when the user terminals are changed from the cell edge users to the cell center users or the user terminals are changed from the cell center users to the cell edge users.

Next, the base station 10 obtains load information of the user terminals in the cell C1 (S720). The base station 10 may measure a queue length of the base station 10 to obtain load information of a downlink and may obtain load information of an uplink through a report from the user terminals.

After The base station 10 classifies into the cell center users and the cell edge users and obtains information on load distribution of the user terminals, the base station 10 analyzes load distribution of the user terminals of a cell using classification of the user terminals and the information on load distribution of the user terminals (S730).

The base station 10 determines the time division interval TB1 for the cell edge users in accordance with load distribution of user terminals of a cell, that is, a load distribution level of a cell center region and that of a cell edge region (S740). As illustrated in FIG. 5, the base station 10 may increase or reduce the time division interval TB1 in accordance with the load distribution level of the cell edge region.

On the other hand, when it is not possible to allocate the time division interval TB1 so as to not overlap the time division intervals TB2 and TB3 allocated for cell edge users of neighboring cells (S750), the base station 10 may allocate the required time division interval TB1 through negotiation with the neighboring cells C2 and C3. When negotiation with the neighboring cells C2 and C3 is required, the base station 10 exchanges resource state information or load distribution information with the base stations 20 and 30 of the neighboring cells C2 and C3 (S760) to share resource state information or load distribution information of the cells C1, C2, and C3. That is, the base station 10 may determine the required time division interval TB1 using the resource state information or the load distribution information of the cells C1, C2, and C3 (S770).

As described above, when the time division interval TB1 is determined, the base station 10 reports information of the time division interval TB1 to the base stations 20 and 30 of the neighboring cells C2 and C3 and terminates a resource allocation process (S780). In addition, the base station 10 may report resource state information and load distribution information of the cell C1 to the base stations 20 and 30.

As described above, the resource allocation process may be divided into an intra-cell load adaptation process (S740) and an inter-cell load adaptation process (S770). In the intra-cell load adaptation process, when resources (that is, the time division interval TB1) required for accommodating cell edge users are allocated, the resource allocation process is completed. In the intra-cell load adaptation process, when required resources are not allocated, an inter-cell load adaptation process is performed.

For the intra-cell load adaptation or the inter-cell load adaptation, resource state information of the base stations 10, 20, and 30 must be shared among the base stations 10, 20, and 30. In addition, resource allocation information changed as a result of resource allocation must be shared among the base stations 10, 20, and 30. Such an information sharing process is performed through interface among the base stations. In a long term evolution (LTE) system, the information sharing process is performed through an X2 interface defined among the base stations.

Two inter-base station processes may be performed for the resource allocation process suggested in the present invention.

Although not shown in the drawing, an interface exists between neighboring base stations (cells) so that information transmission between the base stations is supported. The interface may correspond to the X2 interface in the LTE.

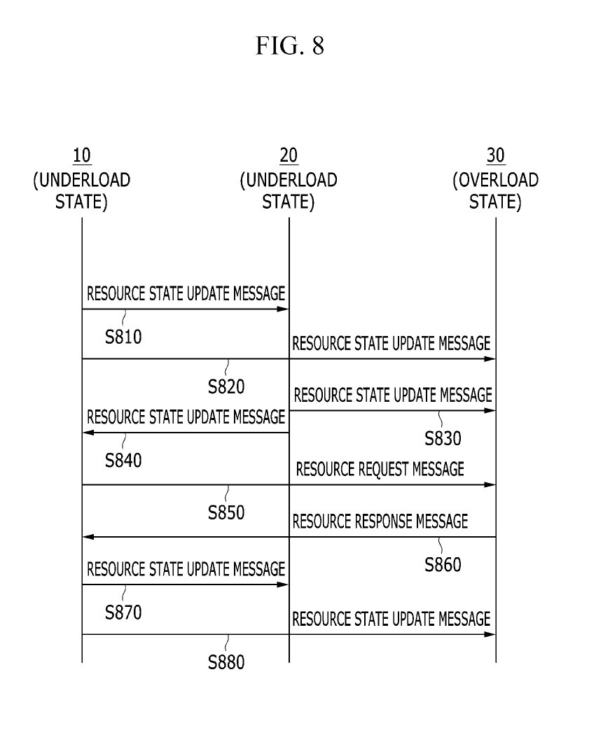

FIG. 8 is a view illustrating an example of a method of exchanging information with neighboring cells according to an exemplary embodiment of the present invention.

The base stations 10, 20, and 30 may report a change in resource allocation information to neighboring cells whenever the resource allocation information is changed. In particular, as illustrated in FIG. 8, when it is assumed that the base stations 10 and 20 are in an underload state where load distribution of user terminals of a cell edge region is low so that resources allocated for cell edge users are not used and are left and the base station 30 is in an overload state where load distribution of user terminals of a cell edge region is high so that resources allocated for cell edge users are insufficient so that resources must be additionally allocated, the base station 10 in the underload state transmits a resource state update message to the neighboring base stations 20 and 30 (S810 and S820). At this time, the resource state update message includes an amount of resources that are not used. The base station 20 in the underload state also transmits the resource state update message to the neighboring base stations 10 and 20 (S830 and S840).

Then, the base station 30 in the overload state transmits a resource request message to one base station 10 of the base stations 10 and 20 in the underload state (S850) to request required resources.

When the base station 10 receives the resource request message from the base station 30, the base station 10 transmits a resource response message to the base station 30 (S860) to approve resources required by the base station 30.

The base station 10 in the underload state where a change is generated in resource allocation transmits the resource state update message to the neighboring base stations 20 and 30 (S870 and S880).

As described above, when the base stations 10 and 20 in the underload state among the base stations 10, 20, and 30 transmit a message including the amount of resources that are not used to the neighboring base station, the base station 30 in the overload state may grasp a base state to which resources are to be requested at the point in time, may request resources to the corresponding base station, and may receive the requested resources.

On the other hand, after the base state 30 in the overload state requests resource state information from the neighboring base station to be reported regarding the resource state information, the base station 30 may search the base stations 10 and 20 in the underload state to request resources and to receive the requested resources.

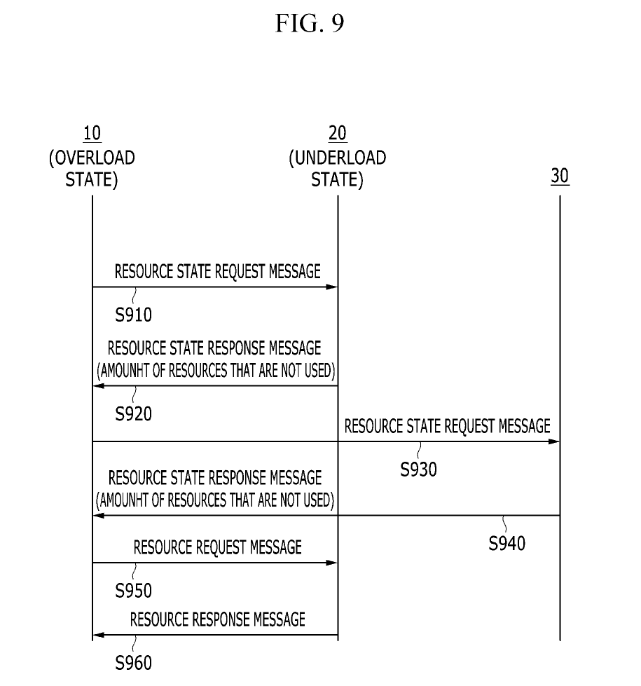

FIG. 9 is a view illustrating another example of a method of exchanging information with neighboring cells according to an exemplary embodiment of the present invention.

In FIG. 9, when it is assumed that the base station 10 is in the overload state and the base station 20 is in the underload state, the base station 10 transmits a resource state request message to the neighboring base stations 20 and 30 (S910 and S930).

When the neighboring base stations 20 and 30 receive the resource state request message from the base station 10, the neighboring base stations 20 and 30 transmit a resource state response message to the base station 10 (S920 and S940). The resource state response message includes an amount of resources that are not used.

The base station 10 selects the base station 20 in the underload state as a base station to which resources are to be requested with reference to the amount of resources that are not used, which is included in the resource state response message received from the neighboring base stations 10 and 20.

The base station 10 transmits a resource request message to the base station 20 (S950) to request required resources.

When the base station 20 receives the resource request message from the base station 10, the base station 20 transmits a resource response message to the base station 10 (S960) to approve resources required by the base station 10.

The information exchange processes with neighboring cells that are illustrated in FIG. 9 have a disadvantage in that a large number of messages are required so that large overhead is generated, however they have an advantage in that base stations that require resources may immediately receive the required resources. On the other hand, the information exchange processes with neighboring cells that are illustrated in FIG. 8 have an advantage in that a small number of messages are required so that small overhead is generated, however they have a disadvantage in that a base station to receive required resources must be first searched so that delay may be generated.

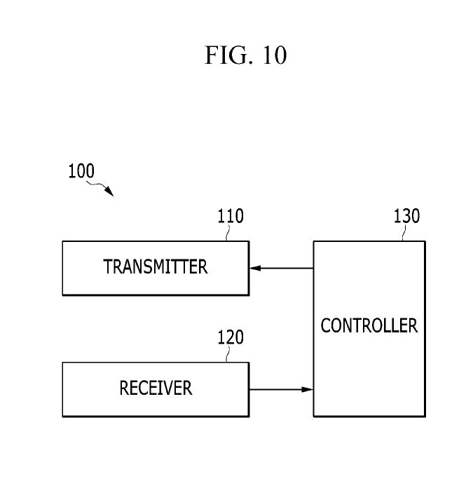

FIG. 10 is a view illustrating an apparatus for allocating resources according to an exemplary embodiment of the present invention.

Referring to FIG. 10, each of the base stations 10, 20, and 30 includes a resource allocating apparatus 100. Hereinafter, description will be made based on the base station 10.

The resource allocating apparatus 100 includes a transmitter 110, a receiver 120, and a controller 130.

The transmitter 110 transmits information on resource allocation to neighboring base stations, and the receiver 120 receives information on resource allocation of neighboring base stations from the neighboring base stations. The information on resource allocation may include information on time division periods, information on time division intervals, and information on load distributions as described above.

The controller 130 performs resource allocation for the intra-cell load adaptation and the inter-cell load adaptation described with reference to FIGS. 2 to 9. The controller 130 divides time resources of one period Tp into a plurality of time division intervals TB1, TB2, and TB3, allocates the time division interval TB1 for user terminals in a cell edge region, and allocates the time division intervals TB2 and TB3 for user terminals in a cell center region. At this time, the time division interval TB2 is allocated for user terminals in a cell edge region of the neighboring cell 20 and the time division interval TB3 is allocated for user terminals in a cell edge region of the neighboring cell 30.

Next, the controller 130 controls the time division interval TB1 in accordance with distribution and load distribution of user terminals in the cell C1. The controller 130 controls the time division interval TB1 in accordance with distributions and load distributions of user terminals in the cells 10, 20, and 30. To be specific, the controller 130 divides user terminals in a cell and analyzes load distribution of user terminals in a cell. The controller 130 determines a time division interval for cell edge users in accordance with load distribution of user terminals in a cell, and may determine a time division interval through negotiation with neighboring cells in some cases.

According to the exemplary embodiment of the present invention, in comparison with a conventional method of dividing resources in a frequency domain to allocate the divided resources, resources are divided in a time domain to be allocated so that an entire frequency band may be used by one cell at a specific point in time and a frequency domain multi-user gain may be improved.

In addition, resource allocation is adaptively performed in consideration of imbalance of load distribution so that resource use efficiency may be improved. Further, inter-cell resource allocation is adaptively performed in consideration of changes in a user distribution and a load level so that it is possible to remove inter-cell interference and to improve resource use efficiency.

Further, since one cell determines resources to be used by the corresponding cell only by a process of exchanging information with neighboring cells, an additional centralized server may not be needed.

The exemplary embodiment of the present invention is not only realized by the above-described apparatus and/or method, but may be realized by a program that performs a function corresponding to a configuration of the exemplary embodiment of the present invention or a recording medium in which the program is recorded. Such realization may be easily performed by those skilled in the art from the description of the above-described exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of a resource allocating apparatus of a first cell allocating resources in a cellular communication system including a plurality of cells, the method comprising:
dividing time resources of one period into a plurality of time division intervals;
allocating one time division interval of the plurality of time division intervals for user terminals in a cell edge region;
allocating time division intervals other than the one time division interval of the plurality of time division intervals for user terminals in a cell center region; and
controlling at least one of a magnitude of one period and a magnitude of the plurality of time division intervals in accordance with distributions and load distributions of user terminals of the plurality of cells.

2. The method of claim 1, wherein the time division intervals other than the one time division interval of the plurality of time division intervals are allocated for user terminals in cell edge regions of neighboring cells of the first cell, respectively.

3. The method of claim 2,
wherein allocating one time division interval of the plurality of time division intervals for user terminals in a cell edge region comprises setting up transmission power in a first level in the one time division interval, and
wherein allocating time division intervals other than the one time division interval of the plurality of time division intervals for user terminals in a cell center region comprises setting up the transmission power in a second level lower than the first level.

4. The method of claim 2, wherein controlling at least one of a magnitude of the one period and a magnitude of the plurality of time division intervals in accordance with distributions and load distributions of user terminals of the plurality of cells comprises:
analyzing distribution of user terminals of the first cell;
analyzing load distribution of user terminals of the first cell; and
determining a magnitude of the one time division interval so that the one time division interval does not overlap the other time division intervals in accordance with distribution and load distribution of user terminals of the first cell.

5. The method of claim 4, wherein determining a magnitude of the one time division interval so that the one time division interval does not overlap the other time division intervals in accordance with distribution and load distribution of user terminals of the first cell comprises determining the one time division interval in proportion to the distribution and the load distribution of the user terminals of the first cell.

6. The method of claim 4, wherein determining a magnitude of the one time division interval so that the one time division interval does not overlap the other time division intervals in accordance with distribution and load distribution of user terminals of the first cell further comprises determining a magnitude of the one time division interval through negotiation with neighboring cells when it is not possible to determine the one time division interval so as to not overlap the other time division intervals.

7. The method of claim 6, wherein determining a magnitude of the one time division interval through negotiation with the neighboring cells comprises:
receiving a resource state update message including an amount of spare time resources from a neighboring cell in an underload state of the neighboring cells; and
requesting required time resources from the neighboring cell in the underload state to receive the requested time resources.

8. The method of claim 6, wherein determining a magnitude of the one time division interval through negotiation with the neighboring cells comprises:
transmitting a resource state request message to the neighboring cells;
receiving a resource state response message including an amount of spare time resources from the neighboring cells;
selecting a neighboring cell in an underload state with reference to the amount of the spare time resources of the resource state response message; and
requesting time resources from the selected neighboring cell to receive the requested time resources.

9. The method of claim 4, wherein analyzing distribution of the user terminals comprises classifying the user terminals into user terminals positioned in a cell edge region and user terminals positioned in a cell center region based on intensities of received signals of the user terminals.

10. The method of claim 9, wherein classifying the user terminals into user terminals positioned in a cell edge region and user terminals positioned in a cell center region based on intensities of received signals of the user terminals comprises receiving intensities of received signals of user terminals of the first cell from the user terminals.

11. The method of claim 9, wherein classifying the user terminals into user terminals positioned in a cell edge region and user terminals positioned in a cell center region based on intensities of received signals of the user terminals comprises measuring intensities of received signals of user terminals of the first cell.

12. An apparatus for allocating resources of a first cell in a cellular communication system including a plurality of cells, the apparatus comprising:
a controller for dividing time resources of one period into a plurality of time division intervals, allocating one time division interval of the plurality of time division intervals for user terminals in a cell edge region, and controlling at least one of a magnitude of one period and a magnitude of the plurality of time division intervals in accordance with distributions and load distributions of user terminals of the plurality of cells; and
a transmitter for transmitting information of the first time division interval to neighboring cells.

13. The apparatus of claim 12,
wherein the controller allocates time division intervals other than the one time division interval of the plurality of time division intervals for user terminals in a cell center region, and
wherein the other time division intervals are allocated for user terminals in cell edge regions of neighboring cells of the first cell, respectively.

14. The apparatus of claim 13, wherein the controller sets up transmission power in a first level in the one time division interval and sets up the transmission power in a second level lower than the first level in the other time division intervals.

15. The apparatus of claim 13, wherein the controller determines a magnitude of the one time division interval so that the one time division interval does not overlap the other time division intervals in accordance with distribution and load distribution of user terminals of the first cell.

16. The apparatus of claim 13, wherein the controller determines the magnitude of the one time division interval through negotiation with the neighboring cells.

17. The apparatus of claim 16, further comprising a receiver for receiving resource allocation messages from the neighboring cells,
wherein, when a message including an amount of spare time resources is received from a neighboring cell in an underload state of the neighboring cells, the controller increases the one time division interval using the spare time resources of the neighboring cell in the underload state.

18. The apparatus of claim 13,
wherein the controller analyzes distribution of user terminals of the first cell and load distribution of user terminals of the first cell and determines the one time division interval in proportion to the distribution of the user terminals of the first cell and the load distribution of the user terminals of the first cell, and
wherein the transmitter transmits the load distribution of the user terminals of the first cell to the neighboring cells.

19. The apparatus of claim 18, further comprising a receiver for receiving load distributions of user terminals of neighboring cells from the neighboring cells,
wherein the controller determines a magnitude of the one period in accordance with load distributions of user terminals of the plurality of cells, and
wherein the magnitude of the one period is changed within limits where delay requirements required by user quality of service (QoS) are satisfied.
